(19) United States
(12) Patent Application Publication
(10) Pub. No.: US 2026/0049920 A1
(43) Pub. Date: Feb. 19, 2026

(54) DEVICE FOR PARTICLE MEASUREMENT AND METHOD FOR PARTICLE MEASUREMENT

(71) Applicant: Robert Bosch GmbH, Stuttgart (DE)

(72) Inventor: Amin Jemili, Kusterdingen (DE)

(21) Appl. No.: 19/261,397

(22) Filed: Jul. 7, 2025

(30) Foreign Application Priority Data
Jul. 2, 2024 (DE) 10 2024 206 199.9

(51) Int. Cl. G01N 15/075; G01N 15/00; G01N 15/0205

(52) U.S. Cl. CPC G01N 15/075; G01N 15/0205; G01N 2015/0046

(57) ABSTRACT

A device for particle measurement having a particle measuring apparatus. The device includes a particle sensor with light signal measurement, wherein the particle measuring apparatus is assigned a sound generation unit emitting a sound signal for generating an air flow. A method for particle measurement using such a device is also described.

### FIELD

The present invention relates to a device for particle measurement and a method for particle measurement using the device.

### BACKGROUND INFORMATION

Various devices and methods for performing a measurement of particle density in an air volume are described in the related art. Available particle measurement sensors are used, for example, in order to determine the distribution of particles with a size of 2.5 μm in an air volume. When using embodiments of such sensors, the sensor is integrated into a complex measuring apparatus. A light barrier provided by the sensor detects, for example, the passage of particles through a measuring channel serving as a measurement volume, in which measuring channel an air flow stimulated by a pump or the like is generated. Another conventional measuring principle uses a particle sensor that emits light and detects the reflected light in order to derive both a movement of the air flow and its volume, which simultaneously represents the measurement volume, and to count the particles carried in the air flow. The particle density in the measurement volume is then calculated based on the ascertained measurement volume.

### SUMMARY

The present invention provides a device for particle measurement and a method for particle measurement using such a device.

Preferred developments of the present invention are disclosed herein.

An idea underlying the present invention is to provide a device for particle measurement that has a particle measuring apparatus having a particle sensor with light signal measurement, wherein the particle measuring apparatus is assigned a sound generation unit emitting a sound signal for generating an air flow. This results in a compact design and greater efficiency when performing particle measurements, since a standardizable and clearly defined air flow is created, which makes faster measurement and determination of the particle density carried in the air flow possible.

According to an example embodiment of the present invention, the particle measurement can be performed as a light signal measurement with a light barrier as a reflection measurement. The light signal is emitted by a light source, for example an LED or laser, into an air volume in which the particles are to be measured. The light striking the particles is scattered by them and a part of the light is reflected back to the particle sensor. The particle sensor, positioned near the light source, detects the reflected light. The intensity and pattern of the reflected light depend on the number and size of the particles. The amount of reflected light is measured and analyzed. The changes in the reflected light signal correlate with the number and size of particles in the air volume. Based on the measurements of the reflected light, the particle density in the air volume is calculated. Reflection measurement offers a reliable method for determining particle concentration by evaluating light scattering and reflection by the particles.

An air flow is generated by the fact that sound waves of the sound signal are emitted into a volume of air. This has a beneficial effect on particle measurement and the measurement volume. The uniform and constant air flow stabilizes the particle concentration and achieves a homogeneous distribution of the particles in the air volume. By controlling the air flow speed and direction, the volume of air flow passing through the measuring region can be precisely defined.

This makes an accurate calculation of the measurement volume and thus the particle density possible. A uniform air flow ensures that the particles are transported evenly and continuously by the light signal in the measuring region.

This leads to more consistent and accurate measurements, since the particles are detected for a defined period of time and under controlled conditions. A constant air flow also prevents particles from settling in the measuring region or adhering to the surfaces of the particle measuring apparatus or particle sensor, reducing measurement errors and the need for frequent cleaning of the device.

The air flow determines the volume of air that is moved through the measuring region per unit of time. A stronger air flow results in a larger measurement volume per unit of time, which increases the number of particles detected and makes more statistically robust data collection possible. A weaker air flow reduces the measurement volume and may lower the detection rate, but may increase the accuracy of detecting smaller particles. Overall, a defined air flow ensures that the conditions in the measuring region are controllable and reproducible, which improves the accuracy and reliability of the particle measurements and allows for faster measurements.

According to a preferred embodiment of the device of the present invention, the sound generation unit can comprise a loudspeaker or a microphone. By using a loudspeaker or a microphone, a defined sound signal can be generated that serves to stimulate an air flow. The use of a loudspeaker or a microphone allows the standardization of the sound signal and thus of the air flow that can be generated. This creates a defined measurement environment with standardized measurement parameters.

According to a preferred embodiment of the device of the present invention, the particle measuring apparatus is integrated into the sound generation unit. This results in advantages with respect to installation space and a compact device can be provided that can also be installed into existing systems, such as mobile apparatuses, in particular mobile phones, tablets, headphones or surveillance cameras, in order to be able to use these apparatuses for particle measurement.

According to a preferred embodiment of the device of the present invention, the particle measuring apparatus is arranged relative to the sound generation unit in such a way that an emission direction of the light signal is aligned orthogonally or parallel to the emission direction of the sound signal. This results in advantages in the configuration and alignment of the device, in particular when it is installed in existing systems or when developing new apparatuses that are intended to implement the device according to the present invention.

It is also possible that the particle measuring apparatus and the sound generation unit are arranged adjacent to one another in a housing. In particular, an emission of the sound signal and/or the light signal into the interior of the housing, which then serves as the measurement volume, can be performed. As a result, the measurement volume is advantageously defined, so that the measuring conditions can be further standardized and advantages for the reproducibility of the measurement are obtained.

It is also possible that the housing comprises an opening and the sound signal and/or the light signal is emitted through the housing opening. For example, the particle measuring apparatus with a particle sensor for light signal measurement can be placed outside the loudspeaker, but in the immediate vicinity of the outlet. As a result, the integration effort of the entire device is reduced, for example when installed in the housing of a mobile apparatus such as a mobile phone or handheld. The particle measuring apparatus can be placed outside the loudspeaker, but in the immediate vicinity of the outlet.

According to a preferred embodiment of the device of the present invention, the device comprising the particle measuring apparatus and the sound generation unit is assigned to an apparatus, in particular a mobile apparatus, or is provided integrated therein. Here, it is possible to use microphones or loudspeakers already present in the apparatus and to easily perform an upgrade of the mobile apparatus by permanently installing or detachably arranging the particle measuring apparatus on the apparatus. The mobile apparatus mentioned in connection with the present invention can be, in particular, a mobile phone, a tablet or other handheld apparatus, such as a notebook, but also headphones (over-ear or in-ear), a microphone, along with a fixed or mobile installed or installable surveillance or other camera with sound output or sound recording capability.

The present invention also relates to a method for particle measurement using a device of the present invention as described above. According to an example embodiment of the present invention, the method comprises emitting a sound signal into an air volume by the sound generation unit and generating an air flow with a defined speed in the air volume, emitting a light signal into the air volume and detecting a reflection of the light signal by the particle measuring apparatus. From this, the particle measuring apparatus then derives a data set for calculating a measurement volume and a density of the particles carried in the measurement volume from the reflected light signal. The data set can, for example, comprise the number of particles counted and the configuration of the sound signal in order to derive the particle speed and the absolute particle number therefrom. From these data, a volumetric quantity, i.e. particles per unit volume, e.g. particles per cm³, can be determined mathematically. It is also possible and equally comprised by the present invention to assign an evaluation unit to the particle measuring apparatus or to connect the particle measuring apparatus to an existing evaluation unit, for example in a mobile apparatus, in order to perform the corresponding calculations.

According to a preferred embodiment of the method of the present invention, the sound signal, which can in particular be designed as an ultrasonic signal, is emitted with a defined oscillation and with a defined duration.

The emission of the sound signal with defined oscillation and duration helps to distribute the particles in the air more evenly. The use of an ultrasonic signal is particularly preferred because it provides a sound source that is inaudible to humans. The sound waves of the sound signal generate pressure differences that cause the particles to be better distributed in the air flow, which results in a more homogeneous particle concentration in the measurement volume. The frequency and intensity of the sound signal can be used to control the speed and volume of the generated air flow. A stronger sound signal can generate a faster and larger air flow, which increases the measurement volume. A weaker sound signal produces a slower air flow and a smaller measurement volume. Ultrasonic signals in particular can generate a uniform and laminar air flow, as a result of which the formation of turbulence is reduced.

A further preferred embodiment of the method of the present invention provides that a calibration of the duration of the emission of the light signal and the performance of the measurement based on the sound signal is performed in each case prior to the commissioning of the device and/or prior to starting the particle measurement.

The calibration of the measuring device, which comprises both the sound source and the light source or particle measuring apparatus, can be performed at different stages, i.e., prior to or after the installation of the device and/or prior to each measurement.

According to an example embodiment of the present invention, an initial calibration of the device can be undertaken prior to installation in order to ensure that the sound source and light source are functioning correctly and measuring precisely. In the laboratory, the sound source and the light source are calibrated by measuring the output power and frequencies by means of calibration apparatuses for sound intensity and light intensity and precise particle counters and comparing them with reference values. The apparatus parameters are then adjusted in order to ensure that they operate within the specified tolerances.

According to an example embodiment of the present invention, after installation or assembly, a system calibration can be carried out in order to ensure that the entire device (sound source, light source and particle measuring apparatus) functions correctly in the provided environment. For this purpose, a calibration of the entire mounted device is carried out in a controlled environment in order to verify whether the components are working together precisely. This can be carried out, for example, by using standardized calibration particles in a defined calibration chamber, whereby when a sound signal and a light signal are emitted by the device, the reflections are detected and compared with known reference values. If necessary, an adjustment of the calibration parameters can then be undertaken in order to increase the measurement accuracy.

According to an example embodiment of the present invention, calibration can also be performed as an operational calibration prior to each measurement, in order to ensure that the measuring device provides accurate and reliable data. For example, a short calibration can be used to check whether changes or drift occur in the measurements. This can be carried out, for example, using installed reference sensors or by means of test modes. In one embodiment, a self-test can be performed prior to the measurement, in which self-test a short sound signal and a light signal are emitted in order to verify functionality. The results are compared with stored reference values and automatically adjusted if necessary. The calibration of the sound source comprises checking the frequency and intensity of the generated sound signal. The calibration of the light source or particle measuring apparatus comprises checking the light intensity and the sensitivity of the particle sensor. The calibration of the entire system comprises checking whether the sound and light sources work together correctly and provide precise measurements.

It is considered to be an advantageous further development of the method of the present invention if the emission of the light signal and the measurement of the reflection are controlled based on the sound signal emitted by the sound generation unit, wherein the particle measuring apparatus is activated in particular by the sound generation unit or the sound signal.

The activation of the emission of the light signal and the measurement of the reflection by the sound signal emitted by the sound generation unit can be carried out, for example, by electronic coupling of the sound generation unit (e.g., the loudspeaker or the microphone) and the particle measuring apparatus (light source and particle sensor).

This coupling can also be achieved through a synchronized control system that coordinates both units. It is also possible to provide a control system, such as a microcontroller or an embedded system, that controls the simultaneous emission of the sound signal and the light signal. For example, a sound signal is emitted in order to generate an air flow and the light signal is activated simultaneously or with a minimal delay.

Alternatively, the sound signal can also be used as a trigger. The particle measuring apparatus is configured in particular so that it is activated by the received sound signal. For example, a microphone or a corresponding sensor in the particle measuring apparatus receives the sound signal and transmits a signal to a microcontroller that activates the light source. In a further possible embodiment, an additional signal processing unit can be provided which evaluates the received sound signal and calculates the optimal point in time for the emission of the light signal.

It is also possible to integrate a microcontroller into the device, wherein the microcontroller is configured to control the sound generation unit and the particle measuring apparatus in a synchronized manner. The microcontroller controls the output of the sound signal and activates the light source and the particle sensor at the right time. In this connection, the microcontroller can also continuously monitor the sound signal, for example through feedback loops and real-time data analysis, and undertake adjustments in order to ensure that the light signal is emitted at the optimal time.

According to an example embodiment of the present invention, a measurement can be performed, for example, as follows: the system is initialized and the microcontroller synchronizes with the connected components (sound generation unit and particle measuring apparatus). The sound generation unit emits a sound signal that generates a defined air flow. A microphone or sensor in the particle measuring apparatus detects the sound signal and sends a signal to the microcontroller. Based on the received sound signal, the microcontroller activates the light source, which then emits a light signal. The particle sensor in the particle measuring apparatus detects the reflection of the light signal caused by the particles contained in the air stream. The light reflection data are collected and analyzed to calculate the particle density.

According to a preferred embodiment of the method of the present invention, the particle measuring apparatus and the sound generation unit are assigned to or integrated into an apparatus, in particular a mobile apparatus. The apparatus then performs the calculation of the measurement volume and the density of the particles carried in the measurement volume based on the data set output by the particle measuring apparatus.

Further features and advantages of embodiments of the present invention will become apparent from the following description with reference to the figures.

### BRIEF DESCRIPTION OF THE DRAWINGS

The present invention is explained in more detail below based upon the exemplary embodiments indicated in the schematic figures.

FIG. 1 is a block diagram of method steps of the method for particle measurement according to an exemplary embodiment of the present invention.

FIG. 2 is a schematic representation of a device for particle measurement according to an exemplary embodiment of the present invention.

FIG. 3 is a schematic representation of a device for particle measurement according to a further exemplary embodiment of the present invention.

In the figures, identical reference signs denote identical or functionally identical elements.

### DETAILED DESCRIPTION OF EXAMPLE EMBODIMENTS

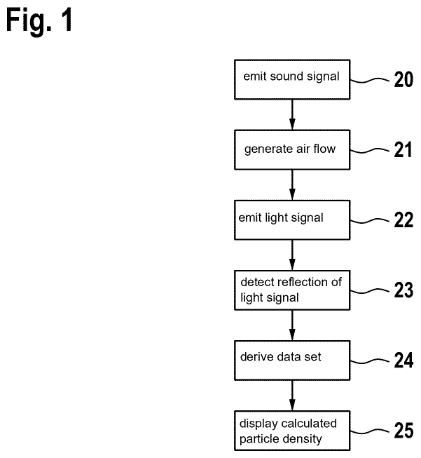

FIG. 1 is a block diagram of the method steps of the method for particle measurement. In the method, in a step 20, a sound signal 107 is emitted into an air volume by the sound generation unit 103 and in the next step 21, an air flow 109 with a defined speed is generated in the air volume. The sound signal 107 is preferably designed with a defined oscillation and with a defined duration, in particular as an ultrasonic signal. In the next step 22, a light signal 106 is emitted into the air volume and in the subsequent step 23 the reflection of the light signal 106 is detected by the particle measuring apparatus 104. In the further step 24, the particle measuring apparatus 104 or an evaluation unit connected thereto derives a data set for calculating a measurement volume and the density of the particles 114 carried in the measurement volume from the reflected light signal 106. In a further step 25, the calculated particle density can be displayed on a display, for example the display of a mobile apparatus, and/or stored in the apparatus.

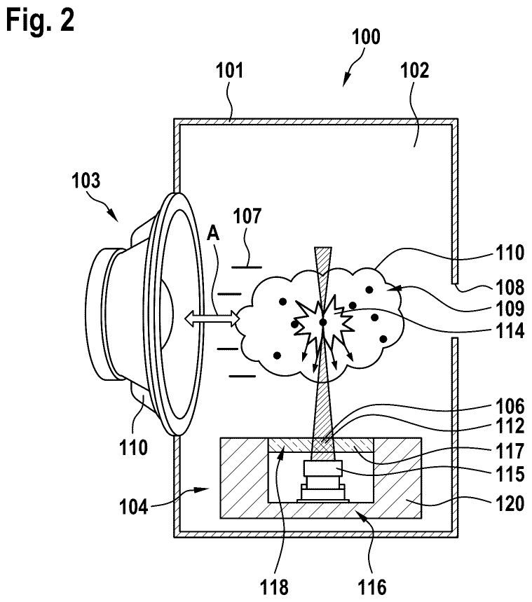

FIG. 2 is a schematic representation of a device 100 for particle measurement according to an exemplary embodiment of the present invention. The device 100 comprises a housing 101 that delimits and defines a measurement volume 102. Both the sound generation unit 103, designed as a loudspeaker 110 in the exemplary embodiment, and the particle measuring apparatus 104 are arranged in the housing 101.

The particle measuring apparatus 104 is combined as a unit 116 in a measuring apparatus housing 120, which comprises a cover 117 that is permeable to the emitted and reflected light signal 106 and comprises a particle sensor 115, with which the particle measurement is performed in the exemplary embodiment. This measurement is performed as a reflection measurement. The light signal 106 is emitted by a light source 112, designed, for example, as an LED or laser, into the measurement volume 102 in which the particles 114 are to be measured. The light signal 106 striking the particles 114 is scattered by them and a part of the light signal 106 is reflected back to the particle sensor 115. The particle sensor 115, which is positioned near the light source 112, detects the reflected portion of the light signal 106. The intensity and pattern of the reflected light signal 106 depend on the number and size of the particles 114. The amount of reflected light signal 106 is measured and analyzed. The changes in the reflected light signal 106 correlate with the number and size of the particles 114 in the measurement volume 102. Based on the measurements of the reflected light signal 106, the particle density in the air volume of a known size is calculated. Reflection measurement provides a reliable method for determining particle concentration by evaluating light scattering and reflection by the particles 114. The sound generation unit 103 and the particle measuring apparatus 104 are housed adjacent to one another in the housing 101. The particle measuring apparatus 104 is arranged in the housing 101 in such a way that a light signal 106 emitted by the particle measuring apparatus 104 is aligned orthogonally to the emission direction of the sound signal 107. The housing 101 has an opening 108 from which the air flow 109 stimulated by the sound signal 107 can exit. Instead of the loudspeaker 110 shown here, an ultrasonic transmitter can also be used. The loudspeaker 110 is positioned so that the sound signal 107 is emitted in a certain direction, in the exemplary embodiment, for example, horizontally in the direction of the arrow A. The sound generation unit 103 emits a sound signal 107, as a result of which an air flow 109 that carries particles 114 is generated. The light source 112 in the particle measuring apparatus 104 emits a light signal 106 that runs orthogonally to the sound signal 107. The light signal 106 passes through the air flow 109 generated by the sound generation unit 107. Particles 114 in the air flow reflect the light signal 106, and the particle sensor 115 detects the reflected light signal 106. The particle sensor 115 is located near the light source 106 to effectively detect the reflections. The adjacent arrangement of the sound generation unit 103 and the particle measuring apparatus 104 in a housing 101 makes a compact design possible and allows the integration of the device 100, for example, in a mobile apparatus such as a mobile phone or a tablet.

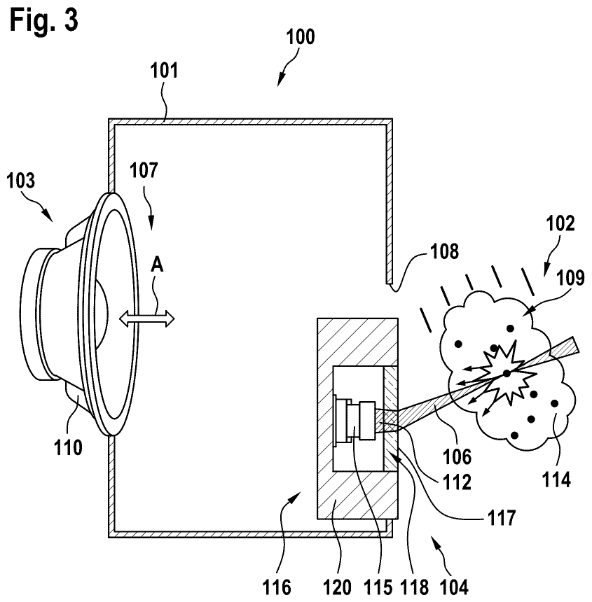

FIG. 3 is a schematic representation of a device 100 for particle measurement according to a further exemplary embodiment of the present invention.

The device 100 also comprises a housing 101 with an opening 108 through which the sound signal 107 exits the housing 101 in the direction of the arrow A. In this exemplary embodiment, the particle measuring apparatus 104 is also equipped with a particle sensor 115 and performs a particle measurement using reflection measurement. With respect to the measurement, reference is made to the explanations in connection with the exemplary embodiment according to FIG. 2. In the exemplary embodiment of FIG. 2, the particle measuring apparatus 104 is arranged in the opening 108 and emits a light signal 106 into the air flow 109 exiting from the opening 108 and stimulated by the sound signal 107. The sound generation unit 103 and the particle measuring apparatus 104 are arranged adjacent to one another in the housing 101. In the exemplary embodiment, however, the particle measuring apparatus 104 is arranged in the housing 101 in such a way that the sound signal 107 and the light signal 106 emitted by the particle measuring apparatus 104 exhibit a substantially similar emission direction, but strike the air flow 109 at an acute angle. The light source 112 and the particle sensor 115 assigned thereto are combined in a measuring apparatus housing 120 forming a closed unit 116, which comprises an exit opening 118 for the light signal 106 with a translucent cover 117 in the emission direction. The cover 117 can be designed in such a way that it causes an alignment or deflection of the light signal 106 in the direction of the air flow 109.

In the exemplary embodiment, the sound generation unit 103 designed as a loudspeaker 110 emits a sound signal 107 that exits the housing 101 through the opening 108. The sound signal 107 generates a defined air flow 109, which carries particles 114 from the ambient air. In this exemplary embodiment, the measurement volume 110 in which the particle determination is performed is located outside the housing 101. The light source 112 of the particle measuring apparatus 104 emits a light signal 106 into the air flow 109 outside the housing 101. The particles 114 carried in the air flow 109 reflect the light signal 106. The particle sensor 115 detects the reflected light signal 106, which is returned to the particle measuring apparatus 104. The data of the reflected light signal 106 are forwarded by the particle sensor 115 to an evaluation unit (not shown) connected to the particle measuring apparatus 104, which evaluation unit calculates the particle density and other relevant parameters, such as the size of the measurement volume 110. The device 100 shown in FIG. 3 allows the integration of all components in a housing 101, so that a compact design is made possible, which can also be implemented in mobile apparatuses such as mobile phones or tablets and can make them usable for particle density determination.

Although the present invention has been completely described above with reference to preferred exemplary embodiments, it is not limited thereto, but can be modified in many ways.

1-13. (canceled)

14. A device for particle measurement, comprising:
a particle measuring apparatus including a particle sensor with light signal measurement;
wherein the particle measuring apparatus is assigned a sound generation unit emitting a sound signal for generating an air flow.

15. The device according to claim 14, wherein the sound generation unit includes a loudspeaker or a microphone.

16. The device according to claim 14, wherein the particle measuring apparatus is integrated into the sound generation unit.

17. The device according to claim 14, wherein the particle measuring apparatus is arranged relative to the sound generation unit in such a way that an emission direction of a light signal is aligned orthogonally or parallel to an emission direction of the sound signal.

18. The device according to claim 14, wherein the particle measuring apparatus and the sound generation unit are arranged adjacent to one another in a housing.

19. The device according to claim 18, wherein the sound signal and/or a light signal is emitted into the housing interior.

20. The device according to claim 19, wherein the housing has an opening, and the sound signal and/or the light signal is emitted through the opening.

21. The device according to claim 14, wherein the particle measuring apparatus and the sound generation unit are assigned to a mobile apparatus, or are integrated into a mobile apparatus.

22. A method for particle measurement using a device including a particle measuring apparatus including a particle sensor with light signal measurement, wherein the particle measuring apparatus is assigned a sound generation unit emitting a sound signal for generating an air flow, and wherein the method comprises the following steps:
emitting a sound signal into an air volume by the sound generation unit and generating an air flow with a defined speed in the air volume;
emitting a light signal into the air volume and detecting a reflection of the light signal by the particle measuring apparatus; and
deriving a data set for calculating a measurement volume and a density of particles carried in a measurement volume from the reflected light signal by the particle measuring apparatus.

23. The method according to claim 22, wherein the sound signal is emitted with a defined oscillation and with a defined duration.

24. The method according to claim 23, wherein the sound signal is an ultrasonic signal.

25. The method according to claim 22, wherein a calibration of the duration of the emission of the light signal and performance of a measurement based on the sound signal is performed in each case prior to commissioning of the device and/or prior to starting a particle measurement.

26. The method according to claim 22, wherein the emission of the light signal and a measurement of the reflection are controlled based on the sound signal emitted by the sound generation unit, wherein the particle measuring apparatus is activated by the sound generation unit or the sound signal.

27. The method according to claim 22, wherein the particle measuring apparatus and the sound generation unit are assigned to or integrated into a mobile apparatus, and the mobile apparatus performs the derivation of the measurement volume and the density of the particles carried in the measurement volume based on the data set output by the particle measuring apparatus.
